(19) United States
(12) Patent Application Publication
(10) Pub. No.: US 2004/0177934 A1
(43) Pub. Date: Sep. 16, 2004

(54) Garage door movement apparatus

(75) Inventor: Robert J. Olmsted, Wood Dale, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 10/385,017

(22) Filed: Mar. 10, 2003

(51) Int. Cl. E05F 15/16

(52) U.S. Cl. 160/188

(57) ABSTRACT

A garage door movement apparatus comprising a garage door vertically movable in tracks to open and close a garage door opening. A jack shaft may be mounted horizontally above the door opening and support a sprocket disposed thereon. A chain may be connected to the door near a bottom thereof and engaged with the sprocket. A spring may be disposed about the jack shaft to provide rotation forces to act against the weight of the door. A track for carrying the garage door is mounted near the garage door opening and has at least a vertical section. In order to convey downward forces on the door from the sprocket, the chain between the sprocket and the door bottom may include a substantially vertical section of a chain guide, which is disposed beneath the sprocket in a direction substantially parallel with the door track.

### FIELD OF THE INVENTION

The present invention relates to barrier movement systems, in particular to systems using jack shaft garage door counterbalance apparatus.

### BACKGROUND

Various types of barrier movement systems such as garage door operators comprise a door opening, a door to cover and uncover opening and guides to keep the door in place. The barriers which open and close vertically are normally relatively heavy and must be counterbalanced so that people or small electric motors can generate sufficient force to open or close the door.

One type of counterbalance consists of a jack shaft mounted horizontally above a door opening with a tension spring around the shaft. A cable is attached to each edge of the bottom of the door and wound around drums at each end of the jack shaft. The jack shaft spring is adjusted to provide rotation force to the jack shaft in a direction to provide an upward force to the door with the cable. In this way the upward force required to raise a 200 lb. door may be reduced to 20-30 lbs. The drums on the jack shaft ends may include cable receiving grooves to properly gather and pay out the cable during the door opening and closing. As the weight of the door is the only force acting to keep the cable taut, rapid changes in the apparent door weight can cause the cable to come off the drum or coil improperly across itself.

The jack shaft arrangement has also been used for automated door movement by controlling a motor which is connected to rotate the jack shaft. In the case of a conventional jack shaft arrangement the addition of a motor alone does not hold the door in the closed position as is the case with an automated rail and trolley drive system. The door needs a lock to prevent break-in, as opening the door from the outside only requires overcoming the balanced weight of the door e.g., 20-30 lbs.

Numerous attempts have been provided to operate the garage door by motorizing the jack shaft to turn the drum and pull the door up by cable. Conventional automatic garage door operators are electromechanical devices, which initiate movement of the garage door to block and unblock a garage door opening in response to actuating electrical signals. A known example of a garage door is a conventional sectional overhead garage door, which comprises a plurality of parallel hinged panels pivoted along pivot axes parallel to the hinge axes, and the pivot axle structures which guided so that the door can follow the locus of the guides. The door normally employs an opening mechanism comprising a motor driving a spring-loaded jack shaft positioned parallel with the upper edge of the door and rotatably mounted above the garage door frame. Balancing the conventional overhead garage door is normally achieved by attaching cables from both sides of the bottom of the door to drums located near each end of the jack shaft. The pull-up cable is taken up on the drum lifting the garage door. The door is closed by the combination of the restoring force of the torsion spring releasing the pull-up cable and the portion of the weight of the door which is unsupported by the tracks or other structures carrying the door.

Therefore, a need exists for a reliable mechanism for a garage door movement apparatus.

### SUMMARY

This need is met and the objects are achieved with the present invention. An embodiment is directed to a garage door movement apparatus comprising a garage door having weight which is vertically movable in tracks to open and close a garage door opening. A jack shaft is mounted horizontally above the door opening and supports a sprocket disposed thereon. A chain is connected to the door near a bottom thereof and engaged with the sprocket. Further, a spring disposed about the jack shaft to provide rotation forces to act against the weight of the door. A track for carrying the garage door is mounted near the garage door opening and has at least a vertical section. In order to convey downward forces on the door from the sprocket, the chain between the sprocket and the door bottom may include a substantially vertical section of a chain guide, which is disposed beneath the sprocket in a direction substantially parallel with the door track.

Preferably, the first end of the chain is connected to the bottom of the door, and the center portion of the chain is engaged with the sprocket and may be moved (stored) within a horizontal section of the chain guide when the door is opening. In one embodiment a rolling chain with a chain guide is used to drive the door. In another embodiment a drive chain is a push-pull chain comprising asymmetrical links for inhibiting bending of the chain. The preferred shape of the asymmetric links is such that to form a rigid thrust mechanism by interlocking the adjacent links when the chain is under compression. The interlocking of the chain links prevents movement of the chain past straight configuration. The garage door opens when the sprocket rotates pulling up the drive chain. It is preferable that the thrust mechanism formed by the guided roller chain on the push-pull chain under compression pushes the door to a closed position and keeps the door closed.

Another embodiment provides powered opening and closing of the door by a reversible electric motor, and the power output of the electric motor is preferably connected to the door by rotating the jack shaft. Embodiments are described in which the rolling chain provides a driving connection between the motor shaft and the sprocket.

The invention may be described with greater clarity and particularity by reference to the accompanying drawings.

### BRIEF DESCRIPTION OF THE DRAWINGS

FIG. 1 is a perspective view of a garage with a garage door in closed position;

FIG. 2 is a perspective view taken from the same position as FIG. 1 but showing the garage with a partially open door driven by a garage door movement apparatus;

FIG. 3 is a perspective view taken from the same position as FIG. 1 but showing the garage with the door in fully open position;

FIG. 4 is a side elevation view of a portion of the garage door movement apparatus with the garage door in closed position;

FIG. 5 is a view of a motorized door movement apparatus showing a roller chain engaged with a sprocket when the door is in open position;

FIG. 6 is a view of the garage door movement apparatus showing a push-pull chain engaged with a sprocket when the door is in closed position;

FIG. 7 is a perspective view of a chain which can convey compression forces;

FIG. 8 is a transparent plan view of the chain of FIG. 7;

FIG. 9 is a perspective view of a chain guide channel;

FIG. 10 shows an end view of the chain guide of FIG. 9;

FIG. 11 shows a chain guide into which a chain has been inserted;

FIG. 12 is a perspective view of a sprocket drive for a roller chain without a jack shaft; and

FIG. 13 is a perspective view of a sprocket drive for a thrust conveying chain without a jack shaft.

### DETAILED DESCRIPTION

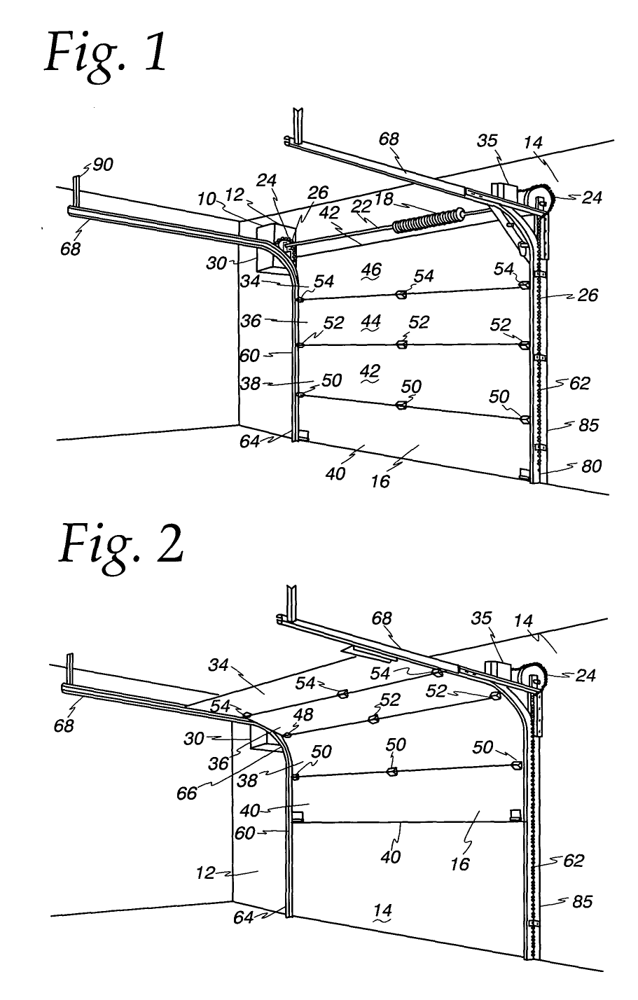

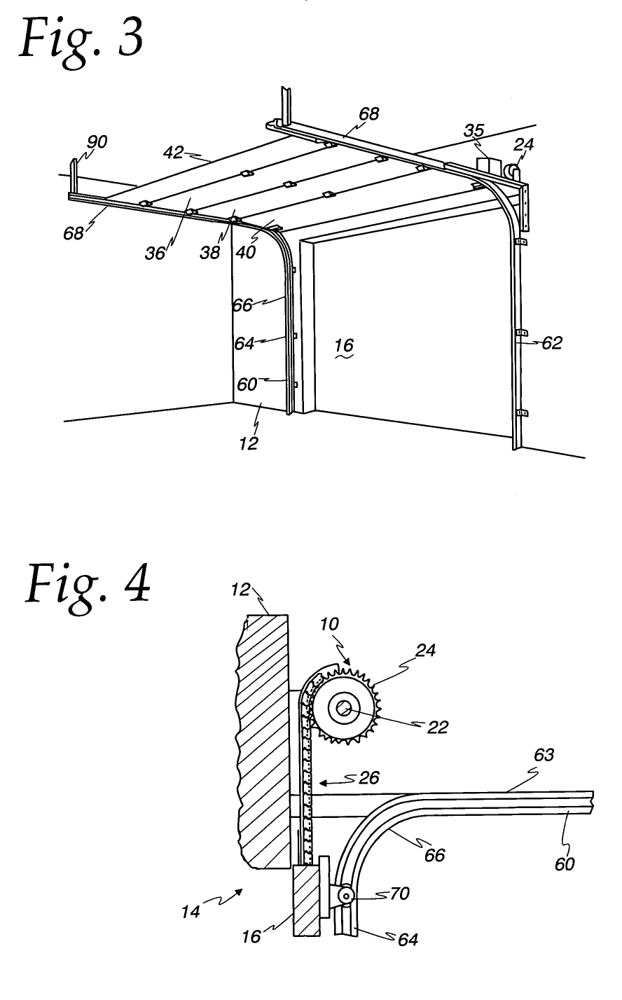

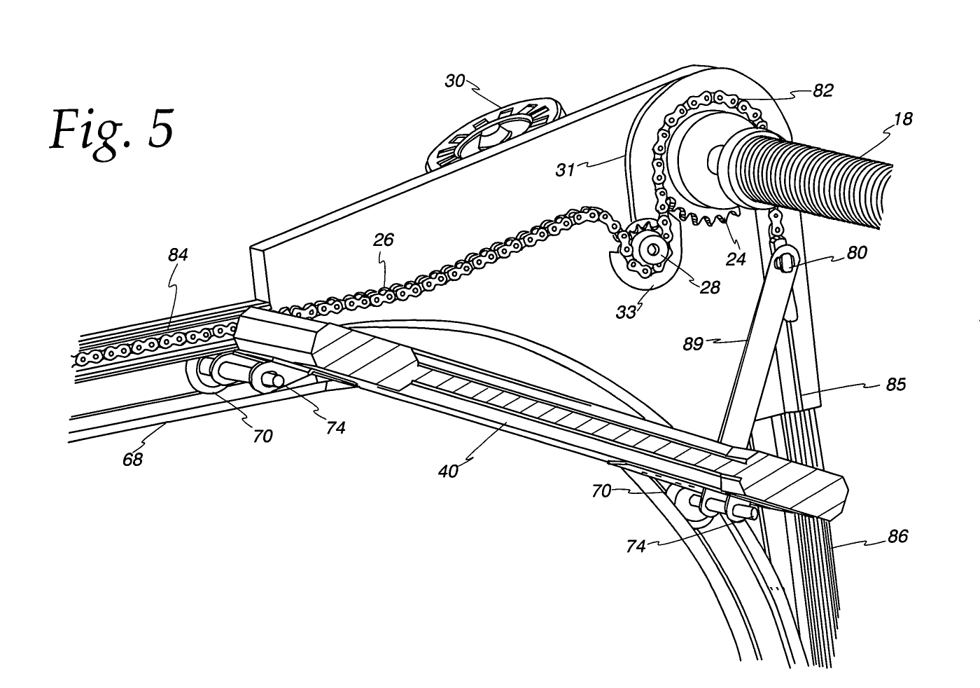

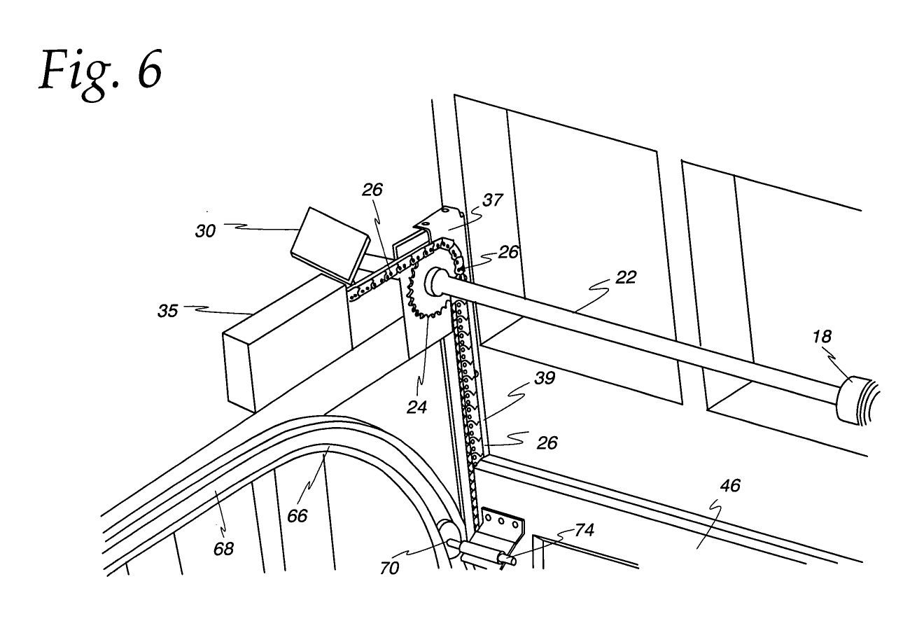

Referring now to the drawings and especially to FIGS. 1-3, a garage door movement apparatus is shown therein. A garage has a garage door opening 14 and a movable sectional garage door 16, which is associated with it. The garage door 16 shown in FIGS. 1-3 is a sectional door consisting of a plurality of rectangular panels 40, 42, 44 and 46. The panels 40 and 42 are connected by a plurality of hinges 50. Panels 42 and 44 are connected by a plurality of hinges 52. Panels 44 and 46 are connected by a plurality of hinges 54. The door is carried on a plurality of rollers in a pair of L-shaped tracks 60 and 62. The exemplary L-shaped track 60 shown in FIG. 1 includes a vertical straight portion 64, a curved portion 66 and a substantially straight horizontal portion 68 suspended by a hanger 90 from the ceiling of the garage. A plurality of rollers 70 positioned on shafts 74 (FIGS. 5 and 6), are attached to the door panels and ride in the track 60 and carry the door panels upward and downward. FIG. 1 shows the garage door in closed position. A jack shaft 22 is mounted horizontally above the door opening and supports a pair of sprockets 24 mounted on either end of the jack shaft to be turned with it. A drive chain 26 is engaged with each sprocket 24 to be pulled upward or pushed downward. Also mounted on the jack shaft 22 are torsion springs 18, which perform a function of counterbalancing part of the weight of the door to reduce the power required to raise the door 16. In the lowered position of the door 16 as shown in FIGS. 1 and 6, the springs 18 are wound to the maximum extent providing a lifting force to counter-balance the weight of the door and reducing the force to be applied to the door in order to lift it. In the elevated position of the door 16 as shown in FIGS. 3 and 5, the springs 18 are partially unwound reducing the counter-balancing force provided. It is preferred that the drive chain is not formed into a loop, but rather has a first and second ends. The drive chain as described herein is a roller chain operating in a guide or a push-pull chain, but it is not limited to those types of chains.

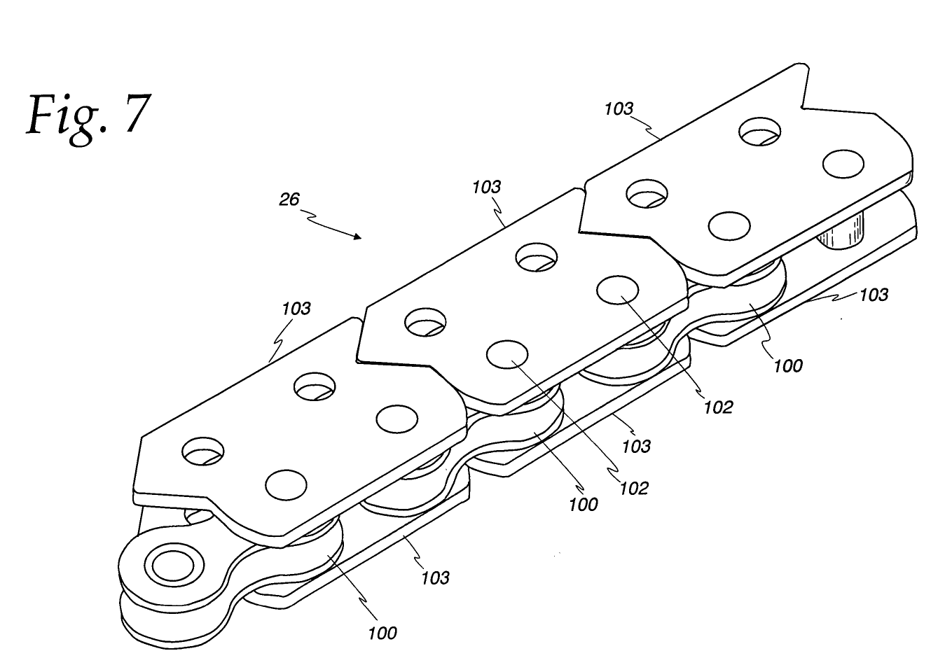

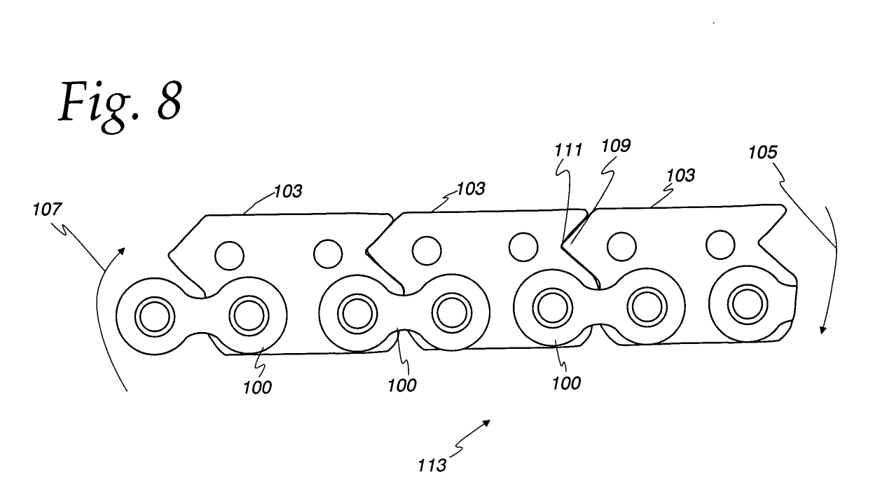

The chain 26 is used in tension to raise and lower the door and, in some situations discussed below, the chain is in compression to start the closing motion and to hold the door closed. One type of chain which can convey forces in compression is a push-pull chain. A portion of a representative push-pull chain is illustrated in perspective in FIG. 7 and in transparent plan in FIG. 8. The push-pull chain consists of a number of roller chain links 100 which may, for example, be bicycle chain links. The roller chain links 100 are coupled by asymmetrical links 103 by means of link pins 102. The links 103 are connected to the roller links 100 so that when the chain is straight, as shown, a V-shaped protrusion 109 of each link 103 contacts a V-shaped notch 111 in the link adjacent to it. Thus, should forces be applied to bend the chain in the direction marked 107 no bending will occur and the chain will remain straight. Alternatively, if forces are applied in the direction 105 the chain is free to bend as any roller chain. The push-pull chain of FIGS. 7 and 8 can be bent around curves concave from directions 113, but it cannot be substantially curved in the reverse direction.

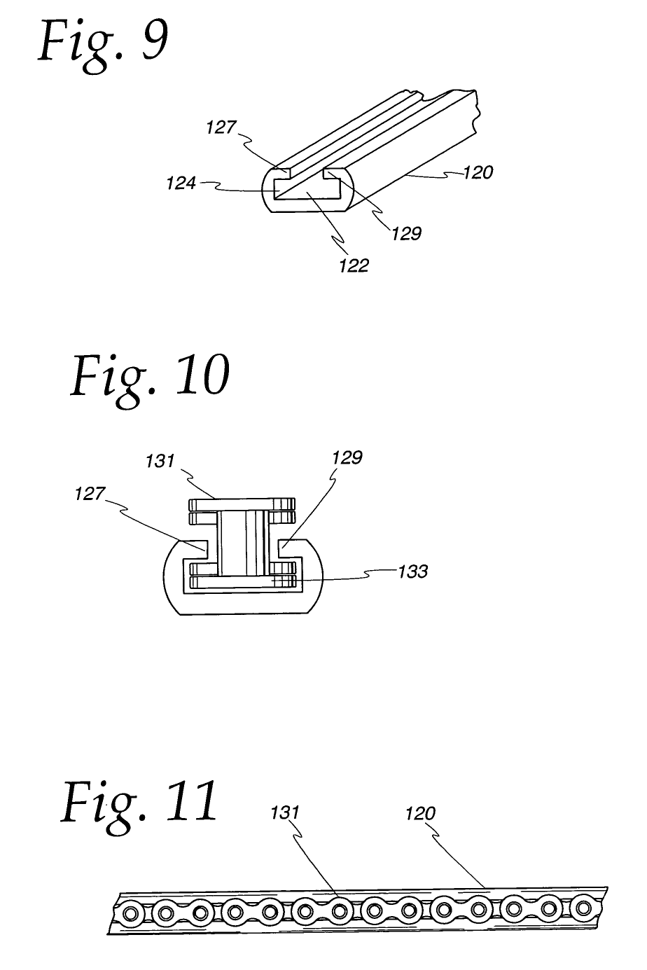

A roller chain can convey forces in compression when it is supported from both sides of its length to keep the chain from bending. Such support can be achieved by passing the chain through a channel of the type shown in FIGS. 9, 10 and 11. The support provided by the channel permits the chain to be a thrust mechanism. The channel 120 is an extruded piece of rigid material such as aluminum or a hard plastic. An opening 122 of substantially rectangular cross section is present in the channel. A void 124 is left throughout the length of the guide 120 to provide access to the chain for connections. The void 124 results in two protrusions 127 and 129 extending toward the center of the top surface of the guide 120. The protrusions can be used to provide anti-bend support to a roller chain. FIG. 10 is an end view of the guide 120 with a chain link 131. The chain slides into the guide so that the protrusions 127 and 129 restrain the side to side movement of the chain rollers e.g., 133. When compression forces are applied to the chain in a guide 120 the chain does not bend and the forces are applied along the chain. It should be noted that a chain guide of the type discussed can be formed in curves and still permit compression forces to be conveyed by the chain. FIG. 11 shows a section of rail 120 having a chain therein.

A first end 80 of the drive chain 26 is connected to the bottom panel 40 of the garage door shown in the open position in FIG. 5. In order to raise the door to a maximum height the connection between the chain end 80 and the door panel 40 is completed by means of a connector 89. FIG. 5 shows the jack shaft sprocket 24 used with a guided chain. In order to stiffen the chain between the sprocket 24 and the door bottom, a chain guide consisting of portions 84, 85 and 86 is provided, a vertical portion 86 of which is disposed beneath the sprocket in a direction substantially parallel with portion 62 of the door track 60. The chain guide 85 and 86 prevent the chain from bending as it is pushed by the drive mechanism when closing or securing the garage door. The center portion 82 of the chain 26 remains engaged with the sprocket 24 when the door is closed, and, when the door opens, the chain 26 moves within the horizontal section of the guide 84 as shown in FIG. 5, or is stored in a magazine (35 FIG. 1). The horizontal portion of the chain guide 84 is adjacent and substantially parallel to the door track portion 68. In FIG. 5, an additional chain guide 31 is used to keep chain 26 on sprocket 24 and a chain guide 31 is used to keep chain 26 on a sprocket 28.

The automated garage door movement apparatus, includes a reversible electrical motor 30 drivingly connected to a jack shaft 22. In operation, when the motor is energized, the jack shaft 22 rotates and the sprocket 24 mounted on the shaft and engaged with a drive chain 26 pulls the chain lifting the door. When the door 16 is lowered, the motor rotates in the opposite direction, and the sprocket 24 pushes the chain 26 downward. FIG. 5 shows the garage door movement apparatus using a portion of the roller chain as a drive chain. In this embodiment the roller chain 26 drivingly engages the sprocket 24 with a drive sprocket 28. The motor 30 is connected (not shown) to rotate drive sprocket 28.

When the door is to be lowered, motor 30 is energized to rotate sprocket 28 in a counter clockwise direction, as shown, and chain 26 rotates sprocket 24 and jack shaft 22 and chain end 80 proceeds downward in guides 85 and 86. The downward movement of the chain 26 moves the door downwardly. It should be mentioned that as the door leaves the open position shown in FIG. 5 the connector 89 becomes near vertical as the door bottom moves nearer the door opening. Also as the door is moving downwardly chain 26 will be withdrawn from the channel 84 or the chain magazine 35. Any attempt to manually raise the door after it is closed requires that chain 26 be moved upwardly which would require rotation of sprocket 28. The connection between motor 30 and sprocket 28 is substantially gear reduced so that the driving of sprocket 28 by chain 26 is a difficult task. When the door is to be raised, motor 30 is energized to rotate sprocket 28 in the clockwise direction which raises the chain end 80 and thus raises the door. In the preceding embodiment motor forces were applied to the chain by sprocket 28. It is to be understood that the motor 30 could be connected to drive jack shaft 22 and sprocket 24 with out the intervening sprocket 28. In such a case sprocket 28 might remain as an idler or it might be replaced by a guide channel.

FIGS. 4 and 6 represent an embodiment in which a push-pull chain is used to move the door. As with the embodiment of FIG. 5 the chain 26 is connected by means of a connector 89 near the bottom of the door. Such is not specifically shown in FIG. 6 which illustrates the door 16 in its closed position. It should be mentioned that chain 26 of FIG. 6 is attached to the door so that the roller link portions 100 face into the garage. Chain 26 of FIG. 6 is thus free to bend around sprocket 24 to engage it. Chain 26 proceeds into a magazine 35 which accumulates the chain before it dangles into the garage. Magazine 35 may be an empty box to accumulate the chain or it may contain a reel which is lightly spring loaded to take up the free chain end. A guide member 37 is disposed over sprocket 24 to retain the chain 26 in contact therewith. Guide member 37 fits between the pairs of asymmetrical plates 103 and the roller links to guide chain 26.

When the door is to be raised motor 30 is energized to rotate sprocket 24 in a counter clockwise direction. The chain 26 applies raising force to the door and the free chain, from sprocket 24 is accumulated in the magazine 35. When the door is to be moved to the closed position motor 30 is energized to rotate sprocket 24 in the clockwise direction. The push pull chain 26 acts as a thrust mechanism when being pushed down. As such, force is first applied to start movement of the door and to keep the door moving. The motor is stopped when the door is in the closed position. Should someone attempt to raise the door from the closed position upward forces would be conveyed by the chain 26 to the sprocket 24. Rotating the motor 30 through its gear reduction by rotating sprocket 24 is a difficult task. Accordingly, the push-pull chain 26 helps to keep individuals from raising the door. Optionally, a guide member 39 may run the length of the door opening to provide structural support to push-pull chain 26. Such a guide would in essence be an extension of guide 37 which covers sprocket 24.

The advantage of the push-pull chain with asymmetrical links is that when the chain is under tension, it can pull the door, and when the chain is under compression, it forms a rigid thrust mechanism by interlocking the adjacent links. The thrust mechanism pushes the door downward and holds it in the closed position preventing it from involuntary opening and brake-in by manually lifting the door from the outside.

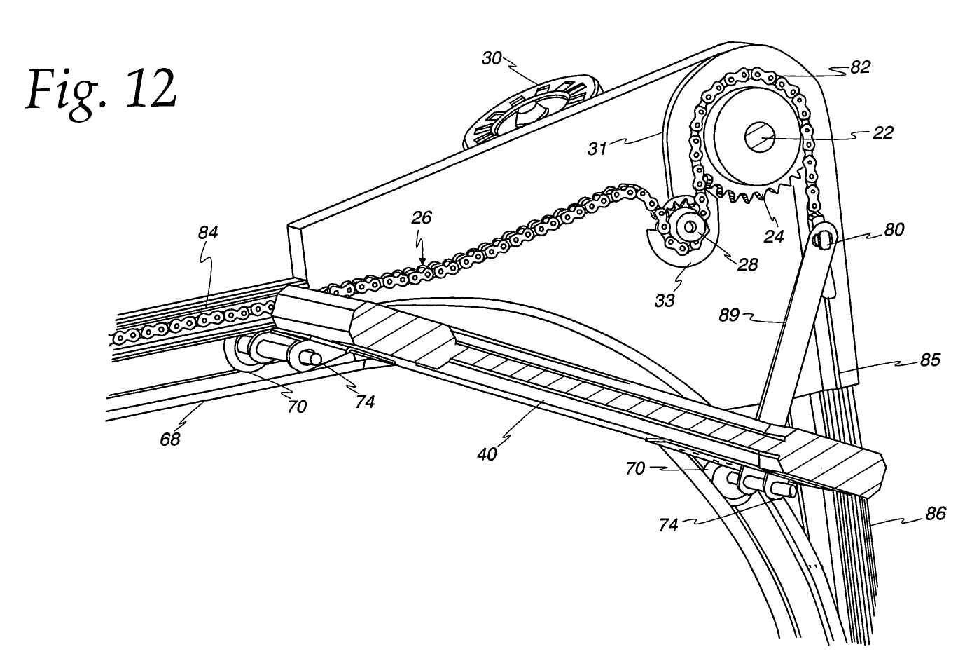

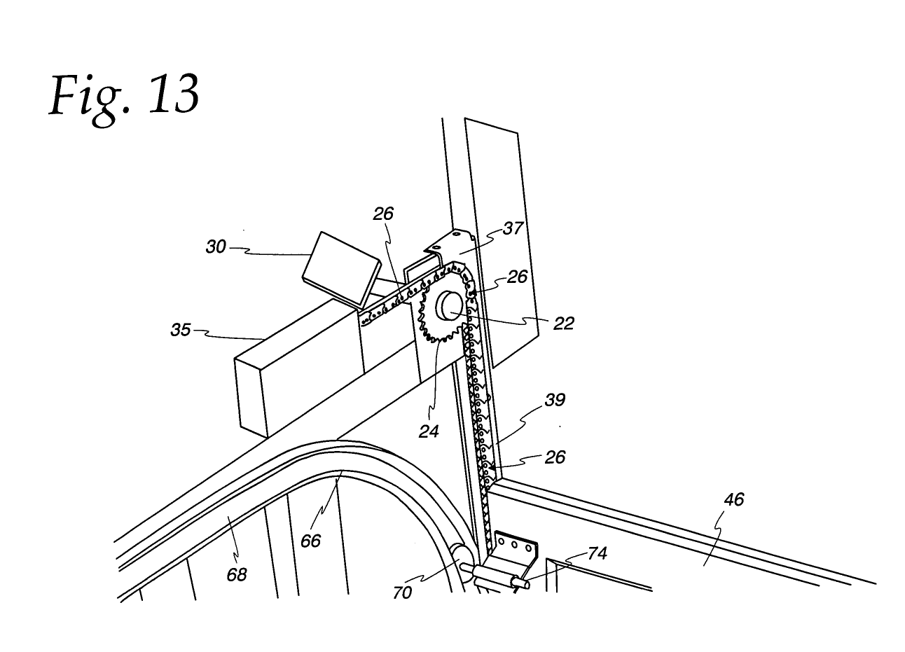

The preceding embodiments include a jack shaft mounted above the door opening to provide automatic drive as well as counterbalance for the door. FIGS. 12 and 13, show modifications of FIGS. 5 and 6 respectively, in which a jack shaft is not employed and a sprocket 24 is mounted above the door opening. The automatic drive force for the door is produced by motor 30 as in the preceding embodiments. Other means such as expansion springs (not shown) above the rails 60 and 62 may be used to counterbalance the door weight.

While there has been illustrated and described particular embodiments, it will be appreciated that numerous changes and modifications will occur to those skilled in the art, and it is intended in the appended claims to cover all those changes and modifications which fall within the true spirit and scope of the present invention. By way of example, the drive chain is presented in the disclosed embodiments as a roller chain and a push-pull chain. The door movement apparatus can employ any other type of flexible chain means within the scope of the present invention.

What is claimed:

1. A barrier movement apparatus comprising:
a barrier movable in a door track to open and close a barrier opening;
a jack shaft mounted substantially horizontally above the barrier opening and supporting at least one sprocket disposed thereon;
a chain having a first end connected to the door and a center portion engaged with the sprocket;
a jack shaft rotation apparatus for providing rotation forces to the jack shaft; and
a chain control apparatus for controlling a portion of the chain between the sprocket and the connection to the barrier to apply forces of compression and forces of tension from the sprocket to the barrier.

2. The barrier movement apparatus according to claim 1, wherein the chain comprises a push-pull chain.

3. The barrier movement apparatus according to claim 2, wherein the chain control apparatus comprises asymmetrical chain links for inhibiting bending of the chain.

4. The barrier movement apparatus according to claim 3, wherein the asymmetrical chain links interlock to prevent movement of the chain past a substantially straight configuration in one direction while allowing movement in the other direction.

5. The barrier movement apparatus according to claim 1, wherein the chain is a roller chain and the chain control apparatus comprises a chain guide through which the chain moves between the sprocket and the connection to the barrier.

6. The barrier movement apparatus according to claim 1, wherein the door track for carrying the garage door is mounted near the barrier opening and comprises a horizontal and a vertical section coupled by a curved section.

7. The barrier movement apparatus according to claim 6, comprising a chain guide means disposed substantially in parallel with the vertical section of the door track.

8. The barrier movement apparatus according to claim 7, wherein a second end of the chain is advanced into a horizontal section of the chain guide when the door is opening.

9. The barrier movement apparatus according to claim 1, wherein the jack shaft rotation apparatus comprises a reversible electric motor for electrically powering the opening and closing of the door.

10. The barrier movement apparatus according to claim 9, comprising a connector for connecting a power output of the electric motor to the sprocket.

11. The barrier movement apparatus according to claim 10, wherein a portion of the chain provides a driving connection between a motor shaft and the sprocket.

12. A barrier movement apparatus according to claim 9, wherein the barrier has weight and the jack shaft rotation apparatus comprises a spring disposed about the jack shaft to provide rotational forces to act against the weight of the barrier.

13. A barrier movement apparatus, comprising:
a barrier movable in a track to open and close a barrier opening;
a jack shaft mounted horizontally above the door opening and supporting at least one sprocket disposed thereon;
a chain having a first end connected to the door and a central portion engaged with the sprocket; and
a chain guide means disposed beneath the sprocket in a direction substantially parallel to a predetermined portion of the track.

14. The garage door movement apparatus according to claim 13, further including a reversible motor for rotating the jack shaft.

15. The garage door movement apparatus according to claim 13, wherein the chain comprises asymmetrical links for inhibiting bending of the chain in a predetermined direction.

16. The garage door movement apparatus according to claim 15, wherein the asymmetric links interlock with adjacent asymmetric links when the chain is under compression to form a substantially rigid thrust mechanism.

17. The garage door movement apparatus according to claim 16, wherein the thrust mechanism pushes the door to a closed position.

18. The garage door movement apparatus according to claim 17, wherein the thrust mechanism resists manually moving the door.

19. A push-pull chain, comprising:
a plurality of pairs of parallel asymmetric outer link plates;
a plurality of pairs of inner chain links disposed between the outer link plates; and
a plurality of pivot pins to sequentially couple alternate pairs of the outer link plates to alternate pairs of adjacent inner chain links to form a chain of adjacent links;
wherein the asymmetric outer link plates comprise a V-shaped projection formed at a front edge and a V-shaped groove formed at a rear edge, the projection of one outer link plate being engageable with the groove of an adjacent outer link plate interlocking the adjacent outer plate and forming a rigid thrust mechanism when the inner chain links and the outer link plates are aligned in one direction.

20. A push-pull chain in accordance with claim 19 wherein the push-pull chain is foldable with ability to mesh with a sprocket drive wheel.

21. The push-pull chain in accordance with claim 19, wherein the pivot pins are aligned when said outer link plates are interlocked.

22. The push-pull chain in accordance with claim 21, wherein a center line of the V-shaped grooves and projections is off-center of the interlocked push-pull chain and spaced from a center line of the aligned pivot pins to prevent the pull-push chain from folding during a linear thrust.

23. The push-pull chain in accordance with claim 19, wherein the pivot pins are spaced so as to provide a sprocket tooth-receiving space therebetween.

24. The push-pull chain of claim 19, wherein the outer link plates are fabricated of a hardened material.

25. A barrier movement apparatus comprising:
a barrier movable in a door track to open and close a barrier opening;
a sprocket mounted above the barrier opening;
a chain having a first end connected to the door and a center portion engaged with the sprocket;
a sprocket rotation apparatus for providing rotation forces to the sprocket; and
a chain control apparatus for controlling a portion of the chain between the sprocket and the connection to the barrier to apply forces of compression and forces of tension from the sprocket to the barrier.

26. The barrier movement apparatus according to claim 25, wherein the chain comprises a push-pull chain.

27. The barrier movement apparatus according to claim 26, wherein the chain control apparatus comprises asymmetrical chain links for inhibiting bending of the chain.

28. The barrier movement apparatus according to claim 27, wherein the asymmetrical chain links interlock to prevent movement of the chain past a substantially straight configuration in one direction while allowing movement in the other direction.

29. The barrier movement apparatus according to claim 25, wherein the chain is a roller chain and the chain control apparatus comprises a chain guide through which the chain moves between the sprocket and the connection to the barrier.

30. The barrier movement apparatus according to claim 25, wherein the door track for carrying the garage door is mounted near the barrier opening and comprises a horizontal and a vertical section coupled by a curved section.

31. The barrier movement apparatus according to claim 30, comprising a chain guide means disposed substantially in parallel with the vertical section of the door track.

32. The barrier movement apparatus according to claim 31, wherein a second end of the chain is advanced into a horizontal section of the chain guide when the door is opening.

33. The barrier movement apparatus according to claim 25, wherein the sprocket rotation apparatus comprises a reversible electric motor for electrically powering the opening and closing of the door.

34. The barrier movement apparatus according to claim 33, comprising a connector for connecting a power output of the electric motor to the sprocket.

35. The barrier movement apparatus according to claim 34, wherein a portion of the chain provides a driving connection between a motor shaft and the sprocket.
